(19) United States
(12) Patent Application Publication
(10) Pub. No.: US 2007/0103696 A1
(43) Pub. Date: May 10, 2007

(54) APPARATUS FOR MEASURING THE POSITION OF AN OBJECT WITH A LASER INTERFEROMETER SYSTEM

(75) Inventor: Harald Pohlmann, Reiskirchen (DE)

Correspondence Address: HOUSTON ELISEEVA, 4 MILITIA DRIVE, SUITE 4, LEXINGTON, MA, 02421, US

(73) Assignee: VISTEC SEMICONDUCTOR SYSTEMS GMBH, Wetzlar (DE)

(21) Appl. No.: 11/554,369

(22) Filed: Oct. 30, 2006

(30) Foreign Application Priority Data
Nov. 4, 2005 (DE) 10 2005 052 757.4

(51) Int. Cl. G01B 11/02

(52) U.S. Cl. 356/498

(57) ABSTRACT

The present invention relates to an apparatus for measuring the position of an object (30), comprising at least one laser interferometer system (29) for determining a position displacement of the object (30) in at least one spatial direction, wherein the at least one laser interferometer system (29), together with the object (30), are accommodated in a climate chamber (40) comprising an area (42) with air intake apertures and an area (44) with air exhaust apertures, wherein it is suggested to provide means for directing in operation at least part of the airflow (46) through the climate chamber (40) into the area of the laser axes (52, 54) of the at least one laser interferometer system (29).

### RELATED APPLICATIONS

This patent application claims priority of German Patent Application No. 10 2005 052 757.4, filed on Nov. 4, 2005, which is incorporated herein by reference.

### FIELD OF THE INVENTION

The present invention relates to an apparatus for measuring the position of an object with at least one laser interferometer system for determining a position displacement of an object in at least one spatial direction, wherein the at least one laser interferometer system, together with the object, is accommodated in a climate chamber comprising an area with air intake apertures and an area with air exhaust apertures.

### BACKGROUND OF THE INVENTION

A measuring device for measuring structures on wafers and masks used for their manufacture has been described in detail in the convention paper entitled “Pattern Placement Metrology for Mask Making” by Dr. Carola Blaesing published for the Semicon, Education Program Convention in Geneva on Mar. 31, 1998. The description given there is the basis for the Leica LMS IPRO coordinate measuring device of the present applicant. For details about the functioning and structure of this measuring device explicit reference is made to the above publication and to the devices presently available on the market (currently Leica LMS IPRO 3). Since the present invention can be advantageously used with such a measuring device and will be primarily described with reference to such a measuring device, without prejudice to its general applicability, this measuring device will be described in the following with reference to annexed FIG. 1. The well-known measuring device 1 is for measuring structures 31 and their coordinates on a sample 30, such as masks and wafers. In the context of the present application, the terms “sample”, “substrate” and the general term “object” are to be regarded as synonymous. In the production of semiconductor chips arranged on wafers with ever increasing integration the structural widths of the individual structures 31 become ever smaller. As a consequence the requirements as to the specification of coordinate measuring devices used as measuring and inspection systems for measuring the edges and the positions of structures 31 and for measuring structural widths become ever more stringent. Optical sampling techniques are still favored in these measuring devices even though the required measuring accuracy (currently in the range of a few nanometers) is far below the resolution achievable with the light wave lengths used (spectral range in the near UV). The advantage of optical measuring devices is that they are substantially less complicated in structure and easier to operate when compared to systems with different sampling, such as X-ray or electron beam sampling.

The actual measuring system in this measuring device 1 is arranged on a vibration-damped granite block 23. The masks or wafers are placed on a measuring stage 26 by an automatic handling system. This measuring stage 26 is supported on the surface of granite block 23 by air bearings 27, 28. Measuring stage 26 is motor driven and displaceable in two dimensions (X/Y). The corresponding driving elements are not shown. Planar mirrors 9 are mounted on two mutually vertical sides of measuring stage 26. A laser interferometer system 29 is used to track the position of measuring stage 26.

The illumination and imaging of the structures to be measured is carried out by a high-resolution microscope optics with incident light and/or transmitted light in the spectral range of the near UV. A CCD camera serves as a detector 34. Measuring signals are obtained from the pixels of the CCD detector array positioned within a measuring window. An intensity profile of the measured structure is derived therefrom by means of image processing, for example, for determining the edge position of the structure or the intersection point of two structures intersecting each other. Usually the positions of such structural elements are determined relative to a reference point on the substrate (mask or wafer) or relative to optical axis 20. Together with the interferometrically measured position of measuring stage 26 this results in the coordinates of structure 31. The structures on the wafers or masks used for exposure only allow extremely small tolerances. Thus, to inspect these structures, extremely high measuring accuracies (currently in the order of nanometers) are required. A method and a measuring device for determining the position of such structures is known from German Patent Application Publication DE 100 47 211 A1. For details of the above position determination explicit reference is made to that document.

In the example of a measuring device 1 illustrated in FIG. 1, measuring stage 26 is formed as a frame so that sample 30 can also be illuminated with transmitted light from below. Above sample 30 is the illumination and imaging device 2, which is arranged about an optical axis 20. (Auto)focusing is possible along optical axis 20 in the Z direction. Illumination and imaging means 2 comprises a beam splitting module 32, the above detector 34, an alignment means 33, and a plurality of illumination devices 35 (such as for the autofocus, an overview illumination, and the actual sample illumination). The lens displaceable in the Z direction is indicated at 21.

A transmitted-light illumination means with a height adjustable condenser 17 and a light source 7 is also inserted in granite block 23, having its light received via an enlarged coupling-in optics 3 with a numerical intake aperture which is as large as possible. In this way as much light as possible is received from light source 7. The light thus received is coupled-in in the coupling-in optics 3 into a light guide 4 such as a fiber-optic bundle. A coupling-out optics 5 which is preferably formed as an achromatic lens collimates the light emitted by light guide 4.

In order to achieve the required nanometer accuracy it is essential to minimize as far as possible interfering influences from the environment, such as changes in the ambient air or vibrations. For this purpose the measuring device can be accommodated in a climate chamber which controls the temperature and humidity in the chamber with great accuracy (<0.01° C. or <1% relative humidity). To eliminate vibrations, as mentioned above, measuring device 1 is supported on a granite block with vibration dampers 24, 25.

The accuracy of determining the position of the structures is highly dependent on the stability and accuracy of the laser interferometer systems used for determining the X/Y stage position. Since the laser beams of the interferometer propagate in the ambient air of the measuring device, the wavelength depends on the refractive index of this ambient air. This refractive index changes with changes in the temperature, humidity and air pressure. Despite the control of temperature and humidity in the climate chamber, the remaining variations of the wavelength are too strong for the required measuring accuracy. An etalon is therefore used to compensate for measuring changes due to changes in the refractive index of the ambient air. In such an etalon a measuring beam covers a fixed metric distance so that changes in the corresponding measured optical length can only be caused by changes in the measuring index of the ambient air. This is how the influence of a change in the refractive index can be largely compensated by the etalon measurement by continuously determining the current value of the wavelength and taking it into account for the interferometric measurement.

To further increase the accuracy, the lines of the laser wavelength can be split up, and additional interpolation algorithms can be used in the calculation of a position displacement.

To describe the accuracy of the measuring device described, usually the threefold standard deviation (3σ) of the measured average value of a coordinate is used. In a normal distribution of measuring values, statistically 99% of the measuring values are within a 3σ range about the average value. Indications as to repeatability are made by measuring a grid of points in the X and Y directions, wherein for each direction, after repeated measuring of all points, an average and a maximum 3σ value can be indicated. In the LMS IPRO measuring device of the applicant, for example, the repeatability (maximum value 3σ) of 4-5 nm could be improved to below 3 nm.

A further improvement of the repeatability and therefore of the measuring accuracy of the measuring device described is desirable. Special attention has been paid in the present invention to the laser interferometer used for coordinate measurement of the measuring stage or for determining changes in the coordinates of this measuring stage. It is noted that the present invention is not limited to interferometers in the context of the measuring device described but can generally be used in laser-interferometric measurements.

From U.S. Pat. No. 5,469,260 an apparatus is known for measuring the position of a one or two dimensionally traversable stage by means of laser interferometry. For this purpose a stationary mirror is attached, for example, on the stationary optical system while the moveable stage carries a mirror along with it. In the well-known manner a laser beam is split in such a way that one part is incident on the stationary mirror while the other part is incident on the mirror which is carried along, and reflected on it. The reflected partial beams are made to interfere with each other wherein, by displacing the interference rings, a relative displacement of the mirror carried along with respect to the stationary mirror can be derived and the amount of this displacement can be determined.

As an example of the above measuring system, in the present document, the position measurement of a wafer support stage during exposure of a wafer through a mask and an optical projection system (stepper) is discussed. Herein the position of the support stage relative to the stationary optical projection system is measured by means of interferometry. To measure the x and y coordinates of the stage in a plane therefore two interferometer systems are necessary.

The above document U.S. Pat. No. 5,469,260 discusses the problem of local atmospheric and therefore fractional fluctuations along the laser axes, i.e. along the optical path of the laser beams which, as fluctuations in the interferometer measuring values, affect and therefore deteriorate the measuring accuracy. Such atmospheric fluctuations result in, for example, temperature differences along the optical measuring path. To solve the problem, in the above document, it is suggested that the laser axes be surrounded with covers and temperature-controlled gas (air) be introduced into the interior of the covers. By correspondingly adjusting the flow velocity of this introduced gas, atmospheric fluctuations of low frequency may be compensated or eliminated. This approach is supposed to increase measuring accuracy in the order of from ±0.04 μm to ±0.01 μm. In this document embodiments of covers of the laser axes and of possibilities for the introduction of temperature-controlled air are disclosed. The air current can be directed in the direction of the laser beam or against it.

This suggested apparatus has a number of drawbacks: on the one hand the covers of the laser axes of an interferometer with the associated feed lines for temperature-controlled air have been found to cause a lot of mechanical and constructive effort, in particular when two interferometers are present for two spatial directions. The covers have been found to cause obstruction during adjustment work. On the other hand, there are differences with respect to temperature, pressure and humidity between the space within the covers and the space without the covers, which can cause interference in the long run. The cover itself, for example, can become an interfering source of heat.

### SUMMARY OF THE INVENTION

It is therefore an object of the present invention to increase the measuring accuracy of a laser interferometer system used in a climate-controlled environment.

The object is solved according to the present invention by an apparatus for measuring the position of an object comprising at least one laser interferometer system for determining a position displacement of the object in at least one spatial direction, wherein the laser interferometer system defines two laser axes, a climate chamber for accommodating the at least one laser interferometer system together with the object, wherein the climate chamber comprising an area with air intake apertures and an area with air exhaust apertures, means for directing in operation at least part of an airflow through the climate chamber into the area of the laser axes of the at least one interferometer system.

The inventive apparatus for measuring the position of an object, comprising at least one laser interferometer system for determining a position displacement of an object in at least one spatial direction, wherein the laser interferometer system, together with the object, are accommodated in a climate chamber having an area with intake apertures and an area with exhaust apertures, is characterized in that means are provided to direct at least part of the flow through the climate chamber to the area of the laser axes of the at least one interferometer system.

The above climate chamber is a chamber having a controlled climate which is isolated as far as possible against external atmospheric influences, wherein at least one of the following parameters is controlled: the composition of the atmosphere in the climate chamber, the temperature, pressure and humidity of this atmosphere. Air is usually chosen as the atmosphere, the temperature and humidity of which are controlled. Therefore, without prejudice to the general applicability, this will be referred to as an airflow.

Surprisingly it has been found that the measuring accuracy of the laser interferometer system used can be significantly improved when the climate chamber comprises a means for selectively controlling at least part of the airflow or the entire flow through the climate chamber into the area of the laser axes of the interferometer system. Often the laser interferometer systems or their associated laser beams are surrounded by structures in the above mentioned apparatuses for position determination, which serve for the mechanical displacement of a sample or the optical detection of a structure. These structures can cause the laser beams of an interferometer to be wholly or partially in the “slipstream” of the flow passing through the climate chamber or can cause the air to be blocked. As a consequence, a laser beam is not or is not uniformly exposed to the airflow through the climate chamber. The atmospheric differences or irregularities, as initially explained, cause fluctuations in the refractive index which negatively affect measuring accuracy. According to the present invention it is therefore ensured that an airflow is directed toward the area of the laser axes of an interferometer with the utmost constancy.

In an advantageous embodiment, the air intake area and/or the air exhaust area of the climate chamber are dimensioned and/or arranged in such a way that at least part of the flow through the climate chamber is directed onto the area of the laser axes. For example, the air exhaust area is arranged near the laser axes of the at least one laser interferometer system so that the main flow through the climate chamber is directed in the direction of these laser axes. At the same time, the exhaust air aperture areas can also be made smaller, for example, causing the flow velocity of the main flow through the climate chamber to be increased. Such an increase in the flow velocity can ensure that a sufficiently strong airflow is present in the area of the laser axes. This is how by a corresponding geometric dimensioning of the air intake aperture and/or air exhaust aperture areas of the climate chamber or by a corresponding arrangement of these areas in the climate chamber it can be ensured that an essentially temporally constant and laminar flow is created in the area of the laser axes. In this area the flow velocity should be at least 0.2 m/s, preferably 0.3 m/s or more.

In a further advantageous embodiment of the invention, baffles are arranged in the climate chamber in such a way that at least part of the flow through the climate chamber is directed onto the area of the laser axes. This can be used together with the first mentioned advantageous embodiment or else independently of it. In particular in the case of structures causing slipstreams, as mentioned above, it may be advantageous to arrange baffles in the climate chamber in such a way that part of the flow is selectively redirected from the air intake aperture area to the air exhaust aperture area of the climate chamber and directed to the area of the laser axes. This can simultaneously cause a local increase in the velocity of the airflow in this area. An essentially temporally constant and laminar flow in the area of the laser axes of an interferometer system can be created by means of air baffles so that during measurements for position determination of an object by means of an interferometer system the atmospheric conditions are not changed, which increases measuring accuracy.

According to another advantageous embodiment, one or more fans can be installed in the area of the laser axes of the at least one interferometer system in such a way that at least part of the flow through the climate chamber is directed toward the area of the laser axes. Again, the arrangement of such fans can be in addition to or independently of the above mentioned two advantageous embodiments. The fans themselves suck in part of the airflow in the climate chamber and give it off with a certain flow velocity in a certain direction. This is how by arranging such a fan the airflow in the climate chamber can be selectively influenced. It should be noted, however, that such additionally arranged fans can be a heat source and sometimes a source of particles. In high-precision measurement devices as they have been mentioned in the introduction to the description, such heat or even particle sources may be found to be undesirable.

In the present invention it is particularly advantageous if the direction of the airflow directed onto the area of the laser axes forms an oblique angle with the direction of a laser axis, which is in an angular range of between 25° and 65°, in particular between 35° and 55°. Since the flow vectors in the area of a laser axis do not have precisely the same direction, there is in practice a certain range of oblique angles to the direction of the laser axis. It has been found to be particularly advantageous if this range is in the area of 45°±10°. When determining a position displacement of an object in two spatial directions (X/Y) two laser interferometer systems are used, the laser axes of which are at right angles to each other. Herein it has been found to be particularly advantageous if the vectors of the airflow directions and each of the laser axes form oblique angles in the plane defined by the laser axes, which are in an angular range of between 25° and 65°, in particular between 35° and 55°. In practice, the airflow should therefore be adjusted in such a way that the airflow direction is roughly in the direction of the bisector of the angle between the two laser axes. This is to ensure that the influence of the directed flow onto the two laser axes is about equal.

### BRIEF DESCRIPTION OF THE DRAWINGS

Exemplary embodiments of the invention and their advantages will be described in the following with reference to the accompanying drawings in more detail, in which:

FIG. 1 schematically shows a coordinate measurement device, in which the apparatus for position measurement according to the present invention can be advantageously used,

FIG. 2 shows measuring results for the X and Y repeatability (FIGS. 2A or 2B) in a measuring system according to FIG. 1 in the manner used according to the prior art,

FIG. 3 shows the measuring values in analogy to FIG. 2, but with a coordinate measurement device with an apparatus for position measurement constructed according to the present invention,

FIG. 4 schematically shows a coordinate measurement device in a climate chamber according to the present invention,

FIG. 5 schematically shows the use of air baffles according to the present invention, and

FIG. 6 schematically shows the use of a fan according to the present invention.

### DETAILED DESCRIPTION OF THE PREFERRED EMBODIMENTS

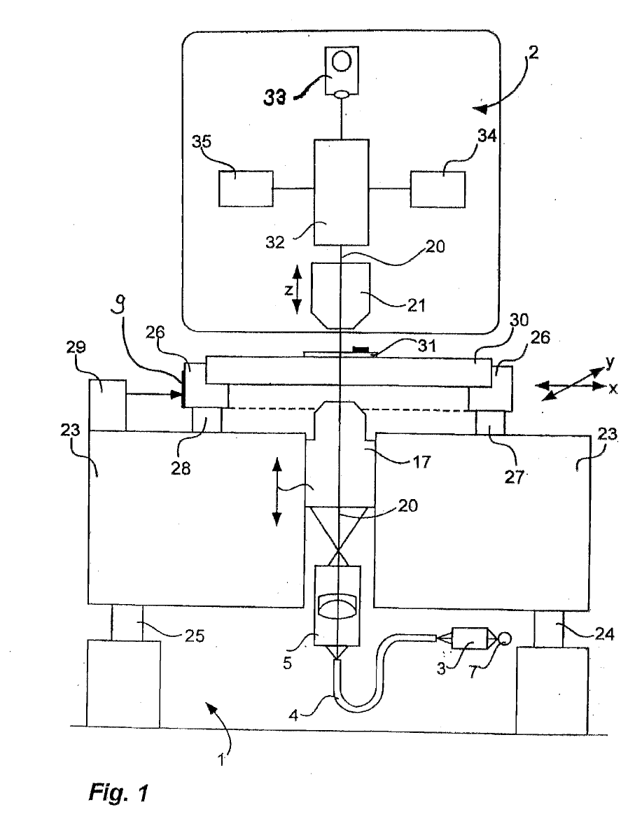

A coordinate measurement device of the type shown in FIG. 1 has been extensively explained in the introduction to the description.

The repeatability or reproducibility of such a coordinate measurement device is usually determined by measuring a measurement grid of 15×15 points (measuring area of 6 inches, 152×152 mm). The value of three times the standard deviation (3σ) is typically determined after 20 measurements for the coordinates found in the X and Y directions. The maximum value of this threefold standard deviation represents the repeatability and therefore the machine performance.

If the measurements are made locally on a defined mask position, i.e. in this case the X/Y measuring stage is not traversed, this is an indication for short-term reproducibility. This measurement gives an indication on the repeatability within a short period of time (so-called needle test).

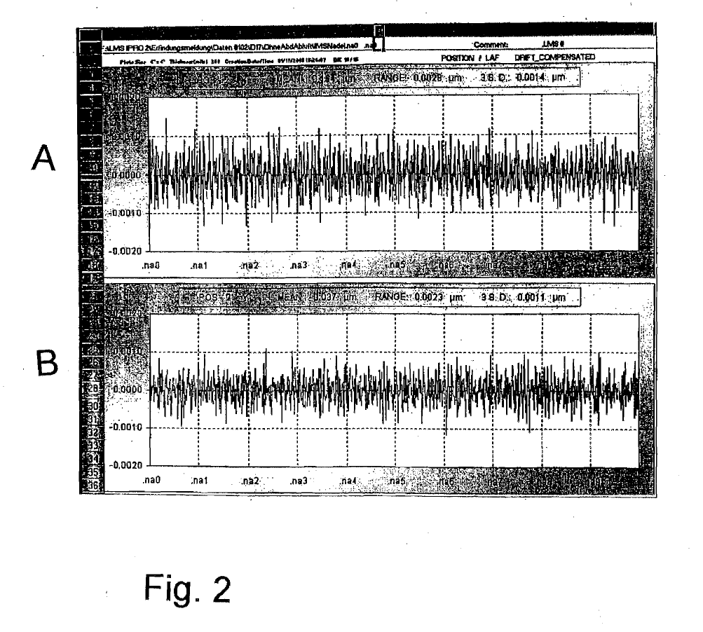

The result of this measurement, more precisely of each value of the maximum threefold standard deviation (repeatability) are plotted in FIGS. 2A and 2B for the X or Y direction, respectively, against the measuring runs. The first measuring run is indicated as .na0, the second as .na1 etc. 100 measuring values are taken per measuring run. The result is a repeatability of 1.4 nm in the X direction and 1.1 nm in the Y direction in a range of 2.8 nm in the X direction or 2.3 nm in the Y direction, respectively, wherein the range represents the difference between the maximum and minimum values and therefore a measure for the noise band.

This exemplary measurement is carried out without modification of the airflow through the climate chamber in which the coordinate measurement device is accommodated.

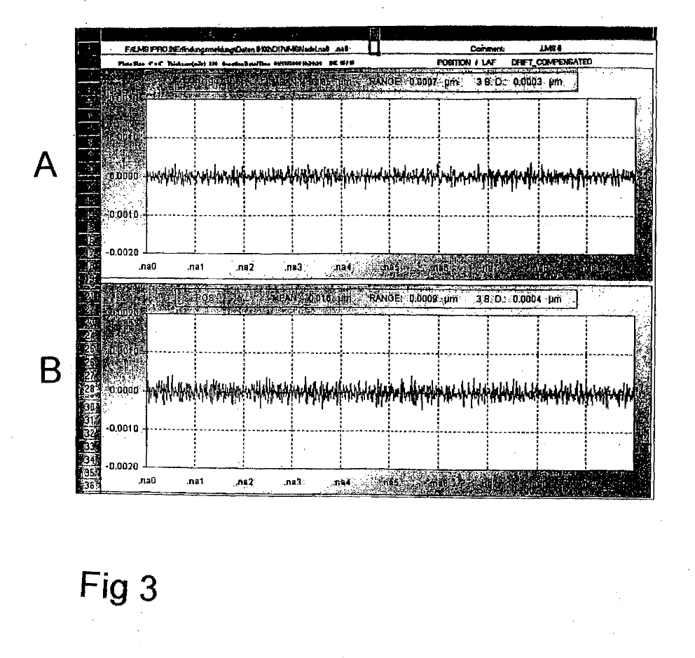

Subsequently the airflow through the climate chamber was changed in such a way that the main portion of the airflow was through the area of the laser axes of the interferometer systems provided for the X and Y directions. FIG. 3 shows the result of the corresponding measurement with modification of the airflow. There are significant differences with respect to the measurements according to FIG. 2. The measures, scales and units plotted correspond to those of FIG. 2. A markedly improved repeatability can be seen. Repeatability (3σ) is 0.3 nm for the X direction, 0.4 nm for the Y direction, with a range of 0.7 nm in the X direction or 0.9 nm in the Y direction, respectively.

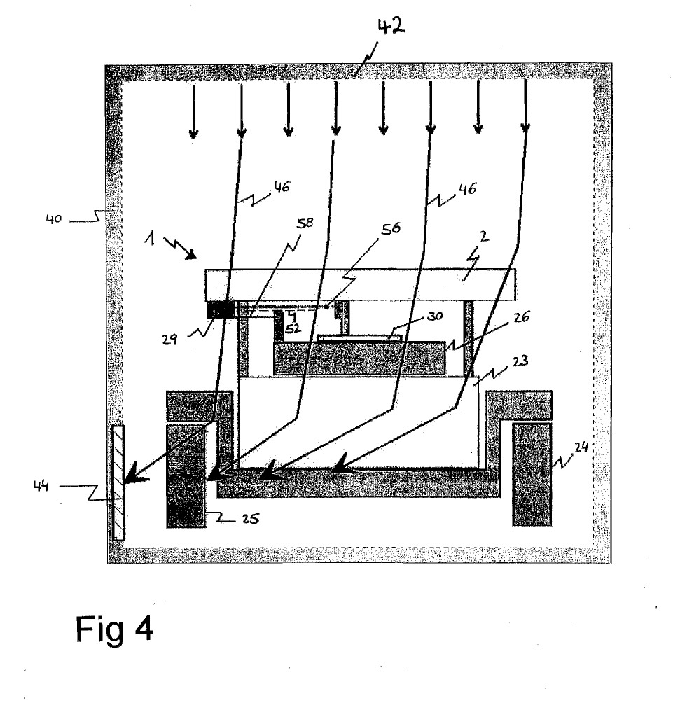

FIG. 4 shows an approach of redirecting the airflow through the climate chamber according to the present invention to the area of the laser axes of the interferometer systems. A climate chamber 40 is shown in which a coordinate measurement device, which is only shown schematically and with the essential elements (cf. FIG. 1), is wholly accommodated. Climate chamber 40 has an area 42 with air intake apertures, from which air flows, the temperature and relative moisture of which are precisely regulated. Climate chamber 40 also has an area 44 with air exhaust apertures, through which the air is sucked from the climate chamber. In this way, an airflow 46 is created within climate chamber 40. In the present embodiment the main portion of the airflow is directed to the area of the laser axes of the interferometer systems which detect the displacements of the X/Y measuring stage 26.

As shown in FIG. 4, interferometer 29 which detects displacements in the X direction and laser axis 52 are schematically shown, wherein laser axis 52 is parallel to reference beam 56 and measuring beam 58 of laser interferometer 29.

It has been found that the present redirection of the airflow can be achieved, for example, by arranging area 44 with exhaust air apertures at a position in climate chamber 40 in such a way that the resulting airflow 46 is via the area of laser axes 52, 54. In an analogous manner, area 42 with air intake apertures can, of course, also be arranged relative to area 44 with exhaust air apertures for the same purpose. By selecting the position of areas 42 and 44 it can be achieved, in particular, that slipstreams or air blockages in the area of the laser axes of the interferometer systems can be avoided. By corresponding dimensioning of areas 42 and 44, moreover, the flow velocity can also be influenced. For example if area 44 with exhaust air apertures, i.e. the area of suction, is reduced, the overall flow velocity of airflow 46 is increased.

It should be noted that in the area of the laser axes of the interferometer systems an airflow is created with the utmost constancy and having flow velocities in the range of between 0.2 and 0.6 m/s, preferably 0.3 and 0.5 m/s. The defined flow velocity in the area of the laser axes ensures improved repeatability of the coordinate measurement device.

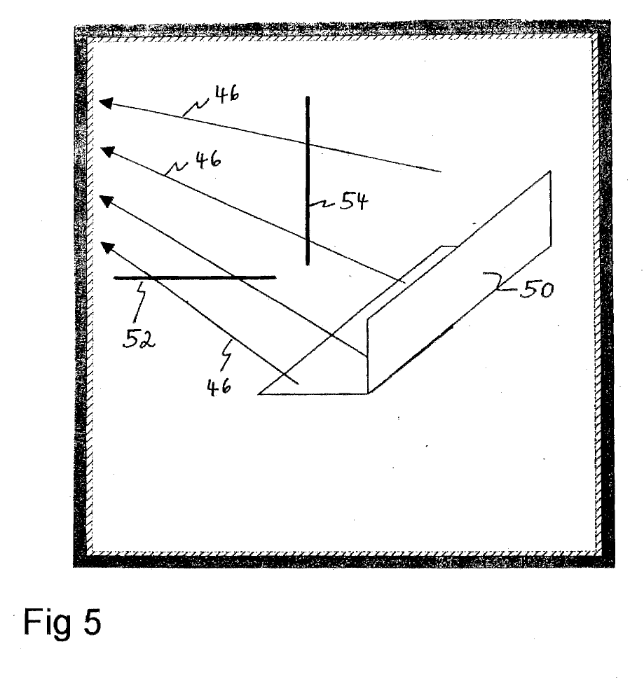

FIG. 5 shows another or additional approach for redirecting the airflow through the climate chamber onto the area of laser axes 52, 54 of the interferometer systems by means of an air baffle 50. Air baffle 50 is introduced into airflow 46 in climate chamber 40 (cf. FIG. 4) in such a way that a redirection of the airflow into the areas of the two laser axes 52 and 54 is achieved. 52 indicates the laser axis in the X direction, and 54 in the Y direction. Air baffle 50 is approximately positioned in such a way that the airflow is directed in the direction of the bisector of the right angle between the two laser axes 52 and 54. This is how the two laser axes have an airflow applied to them having vectors, each enclosing an acute angle with the direction of each of the laser axes, in a range of between about 25° and 65°. The influence on the atmosphere around laser axes 52 and 54 is about the same when this approach is used. As a result the repeatability is increased for both directions in about the same way.

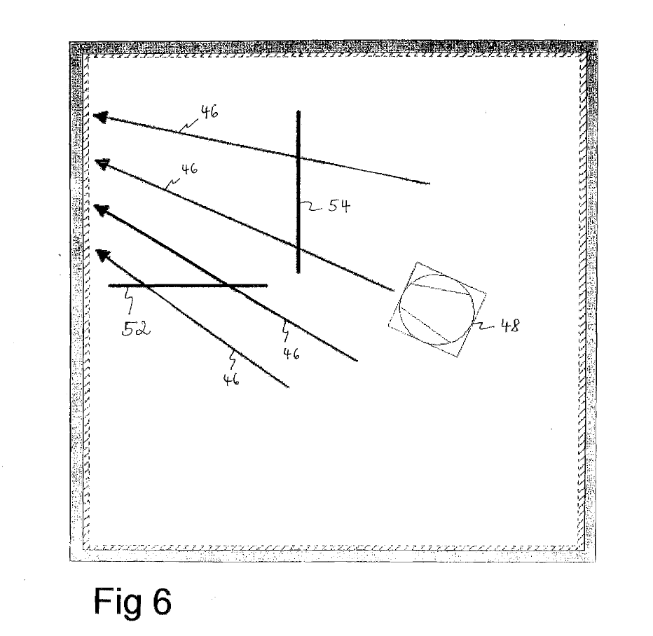

FIG. 6 shows another or an additional approach for redirecting the airflow through the climate chamber into the area of laser axes 52, 54 of the interferometer systems by means of a fan 48. Fan 48 sucks at least part of airflow 46 in climate chamber 40 (cf. FIG. 4) and directs it into the area of the two laser axes 52 and 54. 52, again, refers to the laser axis in the X direction, 54 in the Y direction. Fan 48 is approximately positioned in such a way that the airflow is directed in the direction of the bisector of the right angle between laser axes 52 and 54. The effect is thus essentially the same as that according to the embodiment of FIG. 5. In order to avoid undue repetition, reference is therefore made to FIG. 5.

What is claimed is:

1. An apparatus for measuring the position of an object, comprising at least one laser interferometer system for determining a position displacement of the object in at least one spatial direction, wherein the laser interferometer system defines two laser axes, a climate chamber for accommodating the at least one laser interferometer system together with the object, wherein the climate chamber comprising an area with air intake apertures and an area with air exhaust apertures, means for directing in operation at least part of an airflow through the climate chamber into the area of the laser axes of the at least one interferometer system.

2. The apparatus according to claim 1, wherein the air intake aperture area and/or the air exhaust aperture area of the climate chamber are dimensioned and/or arranged in such a way that at least part of the airflow through the climate chamber is directed into the area of the laser axes.

3. The apparatus according to claim 1, wherein air baffles are arranged in the climate chamber in such a way that at least part of the airflow through the climate chamber is directed into the area of the laser axes.

4. The apparatus according to claims 1, wherein in the area of the laser axes of the at least one laser interferometer system, one or more fans are arranged in such a way that at least part of the airflow through the climate chamber is directed into the area of the laser axes.

5. The apparatus according to claim 1, wherein the direction of the airflow directed into the area of the laser axes encloses acute angles with the direction of one laser axis, in an angular range of between 25° and 65°.

6. The apparatus according to claim 5, wherein the direction of the airflow directed into the area of the laser axes encloses acute angles with the direction of one laser axis, in an angular range of between 35° and 55°.

7. The apparatus according to claim 1, wherein in the determination of a position displacement in two spatial directions when using two laser interferometer systems having laser axes at right angles to each other, the direction of the airflow directed into the area of the laser axes encloses acute angles with the directions of each of said laser axes in the plane defined by the two laser axes, in an angular range of between 25° and 65°, in particular between 35° and 55°.

8. An apparatus for measuring the position of an object, comprising
at least one laser interferometer system for determining a position displacement of the object in at least one spatial direction, wherein the laser interferometer system defines two laser axes,
a climate chamber for accommodating the at least one laser interferometer system together with the object, wherein the climate chamber comprising an area with air intake apertures and an area with air exhaust apertures, and
air baffles are arranged in the climate chamber for directing in operation at least part of an airflow through the climate chamber into the area of the laser axes of the at least one interferometer system, wherein the direction of the airflow directed into the area of the laser axes encloses acute angles with the direction of one laser axis, in an angular range of between 25° and 65°.

9. The apparatus according to claim 8, wherein the direction of the airflow directed into the area of the laser axes encloses acute angles with the direction of one laser axis, in an angular range of between 35° and 55°.

10. An apparatus for measuring the position of an object, comprising
at least one laser interferometer system for determining a position displacement of the object in at least one spatial direction, wherein the laser interferometer system defines two laser axes,
a climate chamber for accommodating the at least one laser interferometer system together with the object, wherein the climate chamber comprising an area with air intake apertures and an area with air exhaust apertures,
one or more fans are arranged in such a way that at least part of the airflow through the climate chamber is directed into the area of the laser axes; and
air baffles are arranged in the climate chamber for directing in operation at least part of an airflow through the climate chamber into the area of the laser axes of the at least one interferometer system, wherein the direction of the airflow directed into the area of the laser axes encloses acute angles with the direction of one laser axis, in an angular range of between 25° and 65°.

11. The apparatus according to claim 10, wherein the direction of the airflow directed into the area of the laser axes encloses acute angles with the direction of one laser axis, in an angular range of between 35° and 55°.
